(19) United States
(12) Patent Application Publication
(10) Pub. No.: US 2026/0051083 A1
(43) Pub. Date: Feb. 19, 2026

(54) UNIVERSAL PHYSICS TRANSFORMERS FOR EFFICIENTLY SCALING NEURAL OPERATORS

(71) Applicant: NXAI GmbH, Linz (AT)

(72) Inventors: Benedikt Alkin, Linz (AT); Johannes Brandstetter, Linz (AT)

(21) Appl. No.: 18/806,925

(22) Filed: Aug. 16, 2024

(51) Int. Cl. G06T 9/40; G06T 9/00

(52) U.S. Cl. CPC G06T 9/40; G06T 9/001

(57) ABSTRACT

A system comprises a Universal Physics Transformer implemented on a data processing apparatus. The Universal Physics Transformer comprises an encoder configured to encode input data into a unified latent representation of the input data in a latent space, an approximator configured to propagate the latent representation of the input data forward in time, and a decoder configured to query the latent representation of the input data at arbitrary query positions.

### TECHNICAL FIELD

The present invention generally relates to the field of neural network system architectures for machine learning, and more particularly to hardware-efficient neural network models which are usable for physics simulations.

### BACKGROUND

Models of physical phenomena are commonly expressed as partial differential equations (PDEs) (Olver, 2014). However, solving most PDEs is analytically intractable and necessitates falling back on compute-expensive numerical approximation schemes.

In recent years, deep neural network-based surrogates, most importantly neural operators (Li et al., 2020a; Lu et al., 2021; Kovachki et al., 2021), have emerged as a computationally efficient alternative (Thuerey et al., 2021; Zhang et al., 2023), and impact e.g., weather forecasting (Lam et al., 2022; Bi et al., 2022; Andrychowicz et al., 2023), molecular modeling (Batzner et al., 2022; Batatia et al., 2022), or computational fluid dynamics (Vinuesa & Brunton, 2022; Guo et al., 2016; Li et al., 2020a; Kochkov et al., 2021; Gupta & Brandstetter, 2022; Carey et al., 2024). In particular, neural operators serving as physics surrogate models have recently gained increased interest.

In addition to computational efficiency, neural operators or neural surrogates offer potential to introduce generalization capabilities across phenomena, as well as generalization across characteristics such as boundary conditions or PDE coefficients (McCabe et al., 2023; Brandstetter et al., 2022b). Consequently, the nature of neural operators inherently complements handcrafted numerical solvers which are characterized by a substantial set of solver requirements, and mostly due to these requirements tend to differ among sub-problems (Bartels, 2016).

However, similar to their numerical counterparts, different neural network techniques are prevalent across applications, even if the underlying dynamics of the systems are similar. For example, when contrasting particle- and grid-based dynamics in computational fluid dynamics (CFD), i.e., Lagrangian and Eulerian discretization schemes. This is in contrast to other areas of deep learning where the flexibility of transformers (Vaswani et al., 2017) has enabled unified architectures across domains, allowing advancements in one domain to also benefit all others. This has lead to an efficient scaling of architectures, paving the way for large “foundation” models (Bommasani et al., 2021) that are pretrained on huge passive datasets Devlin et al. (2018); He et al. (2022).

Unlike the unified architectures across domains enabled by transformers due to their flexibility, neural operators mostly follow a problem specific design, where GNNs are commonly used for Lagrangian simulations and grid-based models predominate Eulerian simulations.

It is therefore an objective of the present invention to provide efficient techniques for scaling neural operators to larger and more complex simulations, ideally by taking into account different types of simulation datasets, thereby overcoming the above-mentioned disadvantages of the prior art at least in part.

### SUMMARY OF THE INVENTION

The above-mentioned objective is solved by the subject-matter defined in the independent claims. Advantageous modifications of embodiments of the present invention are defined in the dependent claims as well as in the description and the drawings.

Certain aspects of the present invention disclosed herein relate to Universal Physics Transformers (UPTs), a framework for efficiently scaling neural operators. In other words, UPTs provide an efficient and unified learning paradigm for a wide range of spatio-temporal problems. In particular, using UPTs, neural operators can be learned efficiently for large problems, such as fluid simulations of large meshes. This is made possible through a special way of encoding physical states of an object, such as a technical system, under consideration very effectively and efficiently, as will be explained in greater detail throughout this disclosure.

According to certain aspects, UPTs operate without grid-or particle-based latent structures, enabling flexibility and scalability across meshes and particles. According to certain aspects,

UPTs efficiently propagate dynamics in the latent space, emphasized by inverse encoding and decoding techniques. According to certain aspects, UPTs allow for queries of the latent space representation at any point in space-time. Diverse applicability and efficacy of UPTs is demonstrated in mesh-based fluid simulations, and steady-state Reynolds averaged Navier-Stokes simulations, and Lagrangian-based dynamics.

One aspect of the present invention relates to a system comprising a Universal Physics Transformer. The Universal Physics Transformer may comprise an encoder. The encoder may be configured to encode input data into a latent representation of the input data in a latent space. The latent representation may be a unified and/or compressed representation of the input data. The Universal Physics Transformer may comprise an approximator. The approximator may be configured to propagate the latent representation of the input data forward in time. The Universal Physics Transformer may comprise a decoder. The decoder may be configured to query the latent representation of the input data, preferably at arbitrary query positions.

This way, Universal Physics Transformers are provided as an efficient and unified neural operator learning paradigm with strong focus on scalability over a wide range of spatio-temporal problems. Universal Physics Transformers can flexibly encode different grids and/or different number of particles into a compressed latent space representation which facilitates scaling to large-scale simulations. Latent space rollouts may be enforced by inverse encoding and decoding surrogates, leading to fast simulated trajectories which is particularly important for large systems. For decoding, the latent representation can be evaluated at any point in space-time. Universal Physics Transformers may operate without grid-or particle-based latent structures and demonstrate the beneficial scaling-behavior of transformer backbone architectures.

The Universal Physics Transformer may be implemented on a data processing apparatus. The data processing apparatus may comprise a memory. The memory may be stored on a storage medium. The Universal Physics Transformer may be implemented by instructions stored on the storage medium of the data processing apparatus that, when executed, implement the Universal Physics Transformer. The Universal Physics Transformer may be provided as an electronic data structure. The Universal Physics Transformer may be configured to be stored on a storage medium of a data processing apparatus and/or configured to be processed by one or more processors of a data processing apparatus. Such a data processing apparatus may comprise one or more computers.

It may be provided that the encoder is configured to encode only an initial state of a system under consideration into the latent representation.

It may be provided that the approximator is configured to iteratively propagate the latent representation forward in time in the latent space.

It may be provided that the encoder is a hierarchical encoder.

It may be provided that the input data comprises a point cloud and/or a surface mesh. The point cloud and/or the surface mesh may represent a contour of the system under consideration.

It may be provided that the encoder is configured to, in a first hierarchy, process a selected plurality of supernodes based on the point cloud.

It may be provided that the encoder comprises a message passing layer configured to pass messages only towards the selected plurality of supernodes.

It may be provided that the encoder comprises one or more transformer blocks and a perceiver block forming a second hierarchy.

It may be provided that the approximator comprises a plurality, in particular a stack, of transformer blocks.

It may be provided that the latent representation uses a predefined fixed number of tokens.

It may be provided that the system according to any of the aspects disclosed herein is used for physics simulation. Accordingly, the aspects disclosed herein may be employed in the context of a method, in particular a computer-implemented method, of simulating and/or optimizing a technical system or device, in particular a shape thereof. As such, the Universal Physics Transformer according to aspects disclosed herein may be configured to be used for simulating and/or optimizing a technical system or device, in particular a shape thereof.

It may be provided that the Universal Physics Transformer is configured to output a simulated and/or optimized design of the technical system or device. The design may be in a machine-readable and/or machine-processable format and/or may include one or more control signals configured to control a technical apparatus configured for building the technical system or device in accordance with the simulated and/or optimized design.

One practical example of a physics simulation relates to computational fluid dynamics (CFD). CFD uses numerical schemes to discretize and solve fluid flows. CFD simulates the free-stream flow of the fluid, and the interaction of the fluid (air, liquids, gases) with surfaces defined by boundary conditions. As such, CFD comprises many challenging phenomena, such as interactions with boundaries, mixing of different fluids, transonic, i.e., coincident emergence of subsonic and supersonic airflow, or turbulent flows. Turbulence (Pope, 2001; Mathieu & Scott, 2000) is one of the key aspects of CFD and refers to chaotic and irregular motion of fluid flows, such as air or water. It is characterized by unpredictable changes in velocity, pressure, and density within the fluid. Turbulent flow is distinguished from laminar flow, which is smooth and orderly. There are several factors that can contribute to the onset of turbulence, including high flow velocities, irregularities in the shape of surfaces over which the fluid flows, and changes in the fluid's viscosity. Turbulence plays a significant role in many natural phenomena and engineering applications, influencing processes such as mixing, heat transfer, and the dispersion of particles in fluids. Understanding and predicting turbulence is crucial in fields like fluid dynamics, aerodynamics, and meteorology.

The technical system or device (also referred to herein as “object under consideration” or “system under consideration”) can virtually be any device which an engineer would like to construct while optimizing it in terms of at least one physical parameter. The technical system or device may be configured to be exposed to a fluid flowing around a contour of said technical system or device. In other words, the technical system or device maybe a fluid-exposed technical system or device, i.e., a technical system or device that is configured to interact with fluids such as air, water or gases. The technical system or device may be a shape-critical fluid-exposed technical system or device, i.e., a technical system or device with a shape that affects its interaction with the surrounding fluid flow. The technical system or device may be a contour-shaped fluid-exposed technical system or device, i.e., a technical system or device that is characterized by a well-defined contour, such as an aerodynamic surface, a hydrodynamic hull, or a heat exchanger's tube bundle, to name just a few examples.

Some illustrative examples of technical systems or devices include, without limitation:

Wind Turbine Blades: A wind turbine's efficiency is heavily dependent on the shape and angle of its blades. By simulating fluid dynamics (CFD) and optimizing blade shapes, energy production can be improved by reducing drag, increasing lift, or adjusting the pitch to maximize power output.

Automotive Aerodynamics: Car manufacturers want to reduce air resistance to improve fuel efficiency and performance. By simulating airflow around a car's body (CFD) and optimizing its shape, drag can be minimized, noise levels can be reduced, or downforce can be enhanced.

Heat Exchangers: In power plants, heat exchangers are crucial for efficient energy transfer between fluids. By simulating fluid dynamics (CFD) and optimizing the shape of tubes, fins, or plates, heat transfer rates can be improved, fouling can be reduced, or overall system performance can be enhanced.

Aircraft Propellers: Optimizing propeller design for improved efficiency, reduced noise levels, or increased thrust requires simulating fluid dynamics (CFD) and optimizing blade shapes, angles, and pitch settings.

Hydroelectric Turbines: By simulating the complex interactions between water flows, turbine blades, and structural components (FEM), turbine design can be optimized for increased power output, reduced vibration, or improved efficiency.

HVAC Systems: Heating, Ventilation, and Air Conditioning systems require efficient air circulation to maintain comfortable indoor environments. By simulating fluid dynamics (CFD) and optimizing duct shapes, fan placement, and control strategies, system performance can be improved, energy consumption can be reduced, or occupant comfort can be enhanced.

Structural Analysis: Building design requires simulating the behavior of structures under various loads (FEM). By optimizing structural components' shapes, materials, and connections, safety can be ensured, costs can be minimized, or building performance can be improved.

The goal of the simulation and/or optimization may be to simulate and/or optimize at least one physical parameter of the technical system or device. The at least one physical parameter may include, without limitation, at least one fluid dynamic parameter.

The at least one physical parameter may include at least one high-level physical parameter, i.e., a parameter that describes overall system behavior or performance, such as thrust force, drag force, lift force, heat transfer rate, or any combination thereof.

The at least one physical parameter may include at least one mid-level physical parameter, i.e., a parameter that characterizes fluid flow and/or interaction with surfaces, such as air flow velocity, water flow velocity, fluid pressure (static and/or dynamic), or any combination thereof.

The at least one physical parameter may include at least one low-level physical parameter, i.e., a parameter that describes local conditions, such as temperature, stress distributions (tensile, compressive, shear), or any combination thereof.

The at least one physical parameter may include at least one microscopic physical parameter, i.e., a parameter that that describes the behavior of individual components or molecules, such as turbulence intensity.

A non-exhaustive list of examples of the at least one physical parameter includes: air flow velocity, pressure (static and/or dynamic), turbulence intensity, drag force, lift force, fluid flow velocity, temperature, heat transfer rate, water flow velocity, stress (tensile, compressive and/or shear), strain (linear and/or nonlinear), displacement, humidity, or any combination thereof.

Exemplary use cases of a physics simulation include, without limitation, turbulence simulation, steady state flow simulation, transient flow simulation, fluid dynamics simulation, Lagrangian dynamics modeling simulation, Lagrangian fluid dynamics simulation, particle-based simulation, or any combination thereof.

Another aspect of the present invention concerns a data processing apparatus. The data processing apparatus may be configured for storing and/or executing any of the Universal Physics Transformers disclosed herein.

Another aspect of the present invention concerns a computer program or a computer-readable medium having stored thereon a computer program. The computer program may comprise instructions which, when the program is executed by a computer, cause the computer to implement any of the Universal Physics Transformers disclosed herein.

The terms used herein should generally be construed as understood by the average person skilled in the art, unless explicitly indicated otherwise. The following explanations may guide the understanding:

The term “artificial Intelligence” (Al) should be understood as referring to a branch of computer science that aims to develop machines or software capable of intelligent behavior, typically with the goal to mirror or surpass human intelligence in specific tasks. Al systems are designed to perform complex tasks such as reasoning, learning, perception, problem-solving, and understanding natural language. These systems can typically adapt to new situations and improve their performance over time. The goal of Al is to create systems that can function autonomously and interact with their environment in a human-like manner.

The term “machine learning” (ML) should be understood as a subset of artificial intelligence that focuses on the development of algorithms and statistical models that enable computers to perform specific tasks without using explicit instructions. Instead, machine-learning systems learn and make predictions or decisions based on data. Machine-learning algorithms build a mathematical model based on sample data, known as training data, to make predictions or decisions without being explicitly programmed to perform the task. Machine learning can be employed in a variety of applications, including image and speech recognition, medical diagnosis, predictive analytics, and many more, where it enables systems to learn from and adapt to new data independently.

The term “machine-learning algorithm” should be understood as a computational procedure that is designed to analyze data, learn from it, and identify patterns or make decisions based on the input data without being explicitly programmed for the task. Machine-learning algorithms leverage statistical techniques to enable systems to improve their performance on a specific task with more data over time. Machine-learning algorithms are the foundation upon which machine-learning models are built, providing the methods or processes through which data is transformed into actionable insight. Examples of machine-learning algorithms include linear regression, decision trees, support vector machines, and neural networks, among others.

The term “machine-learning model” should be understood as referring to the output generated when a machine-learning algorithm is trained on a dataset. It represents the knowledge or understanding gained by the algorithm from the data, encapsulating the learned patterns or predictions. Essentially, a machine-learning model is what enables predictions or decisions based on new, unseen data, based on the learning it has derived from the training process. The machine-learning model is typically defined by its parameters, which may be adjusted during the training phase to minimize the difference between the predicted outcome and the actual outcome. Although, strictly speaking, “machine-learning algorithm” and “machine-learning model” have distinct definitions, it is not uncommon for these terms to be used interchangeably in casual discourse. This usage stems from the close relationship between algorithms and models in the workflow of machine-learning projects, where the algorithm is the means of creating the model. Therefore, these terms may be used synonymously herein unless the distinction is decisive.

The term “artificial neural network” (ANN), or “neural network” (NN) in short, should be understood as a machine-learning or deep-learning model or algorithm. Neural networks are generally inspired by the human brain and typically comprise interconnected nodes or neurons organized into layers. Neural networks can be used to process data and learn from examples, enabling them to perform tasks such as image recognition, natural language processing, and more. A neural network typically comprises an input layer, one or more hidden layers, and an output layer. Through a process called training, neural networks can learn to perform specific tasks by adjusting their internal parameters, or “weights”, based on labeled or unlabeled data.

The term “training” should be understood as referring to the process of teaching a machine-learning model to make predictions or decisions, by exposing it to data for which the outcomes are known. The training process typically involves feeding a training dataset into a machine-learning algorithm, which then uses statistical analysis to learn the patterns or relationships within the data. During training, the algorithm iteratively adjusts the parameters of the model to minimize the difference between the predicted outcomes and the actual outcomes in the training data. This adjustment process is typically guided by a loss function, which measures the accuracy of the model's predictions. The goal of training is to produce a model that accurately represents the underlying structure of the data, enabling it to make reliable predictions about new, unseen data. Supervised learning involves training a model on a labeled dataset, where each example in the training data is paired with the correct output. The model learns to predict the output from the input data. Unsupervised learning involves training a model on data without labeled responses. The model tries to find patterns and relationships in the data on its own. Semi-supervised learning combines both labeled and unlabeled data during the training process, which can be beneficial when acquiring a fully labeled dataset is costly or impractical.

The term “Transformer model” should be understood as a type of neural network model that is distinguished by its exclusive reliance on attention mechanisms, eschewing recurrent layers to process sequential data. At the core of the Transformer is the self-attention mechanism, which enables each position in the sequence to attend to all positions in the previous layer of the model simultaneously. This global perspective is said to allow the model to learn context and relationships between words or elements in the input sequence, regardless of their positional distance from each other. The Transformer model typically comprises an encoder and a decoder. The encoder processes the input sequence and transforms it into a continuous representation that holds all the learned information of that sequence. Each encoder layer typically has two sub-layers: a multi-head self-attention mechanism and a position-wise fully connected feed-forward network. The decoder generates the output sequence based on the encoder's representation and the previously generated elements. Each decoder layer typically has three sub-layers: a multi-head self-attention mechanism, a multi-head attention mechanism over the encoder's output, and a position-wise fully connected feed-forward network.

The term “Neural operator” should be understood as referring to a class of deep learning architectures designed to learn maps between infinite-dimensional function spaces. Neural operators represent an extension of traditional artificial neural networks, marking a departure from the typical focus on learning mappings between finite-dimensional Euclidean spaces or finite sets. Neural operators directly learn operators between function spaces; they can receive input functions, and the output function can be evaluated at any discretization. The primary application of neural operators is in learning surrogate maps for the solution operators of partial differential equations (PDEs), which are critical tools in modeling the natural environment. Standard PDE solvers can be time-consuming and computationally intensive, especially for complex systems. Neural operators have demonstrated improved performance in solving PDEs compared to existing machine learning methodologies while being significantly faster than numerical solvers. Neural operators have also been applied to various engineering disciplines such as turbulent flow modeling, computational mechanics, graph-structured data, and the geosciences. In particular, they have been applied to learning stress-strain fields in materials, classifying complex data like spatial transcriptomics, predicting multiphase flow in porous media, and carbon dioxide migration simulations. Finally, the operator learning paradigm allows learning maps between function spaces, and is different from parallel ideas of learning maps from finite-dimensional spaces to function spaces, and subsumes these settings when limited to fixed input resolution.

### BRIEF DESCRIPTION OF THE DRAWINGS

The invention may be better understood by reference to the following drawings:

FIG. 1: A schematic overview of a Universal Physics Transformer learning paradigm in accordance with embodiments of the invention.

FIG. 2: Qualitative exploration of scaling limits. Starting from 32K input points (scale 1), we train a 68M parameter model for a few steps with batchsize 1 and measure the required GPU memory. “LT” denotes a transformer with linear attention. Models without a compressed latent space (GNN, LT) quickly reach their limits while models with a compressed latent space (GINO, UPT) scale much better with the number of inputs. However, as GINO compresses the latent space onto a regular grid, the scaling benefits are largely voided on 3D problems. The efficient latent space compression of UPTs can fit up to 4.2M points (scale 128).

FIG. 3: A schematic overview of a Universal Physics Transformer architecture in accordance with embodiments of the invention. The encoder compresses information from various grids or differing particles. Subsequently, this information is propagated forward in time through the approximator and decoded at arbitrary query positions.

FIG. 4: A schematic overview of a Universal Physics Transformer training procedure to enable latent rollouts in accordance with embodiments of the invention. To separate the responsibilities of the individual components, we introduce inverse encoding and decoding losses in addition to the next step prediction loss.

FIG. 5: Example rollout trajectories of a Universal Physics Transformer model in accordance with embodiments of the invention.

FIG. 6: Transient flow results. MSE and correlation time on the testset. UPTs outperform compared methods on all model scales by a large margin.

FIG. 7: Discretization convergence of the 68M parameter models from FIG. 6. Left: We vary the number of input/output points of models that were trained on inputs between 8K and 24K points and 8K target points. UPT demonstrates a stable performance across different number of input/outputs even if it has never seen that number of input/output points during training. Right: Increasing the number of supernodes improves the performance of UPT despite being trained with 2K supernodes. GINO was trained with 4K gridpoints.

FIG. 8: Latent space scaling investigations of a 17M parameter UPT model for 10 epochs. Compound scaling scales the number of supernodes and latent tokens simulataneously where a compound scale of 1 uses supernodes=2048 and nlatent=512, i.e. compound scale 2 uses nsupernodes=4096 and nlatent=1024. Throughput is measured as number of samples processed per GPU-hour. Models are trained in a reduced setting with 10 epochs and 16K input points.

FIG. 9: Conceptual difference between GNS/SEGNN on the left and UPT on the right side. GNS/SEGNN predicts the acceleration of a particle which is then integrated to calculate the next position. UPTs directly model the velocity field and allow for large timestep predictions.

FIG. 10: (Top) Mean Euclidean norm of the velocity error over all particles for different timesteps. UPTs effectively learn the underlying field dynamics, resulting in lower velocity error as the trajectory evolves in time. (Bottom left) Visualization of the velocity field modeled by UPT (depicted in white) compared to the ground truth particle velocities. (Bottom right) Comparison of simulation/rollout runtimes for a TGV2D trajectory with 125 timesteps and 2500 particles across SPH simulation, GNS/SEGNN, and UPT, which has an inference time that results in a 98-fold speedup compared to SPH, a 55-fold speedup compared to SEGNN and a 11-fold speedup compared to GNS.

### DETAILED DESCRIPTION

In the following, representative embodiments illustrated in the accompanying drawings will be explained. It should be understood that the illustrated embodiments and the following descriptions refer to examples which are not intended to limit the embodiments to one preferred embodiment.

In certain embodiments, Universal Physics Transformers (UPTs) are provided as an efficient and unified neural operator learning paradigm with strong focus on scalability over a wide range of spatio-temporal problems. UPTs flexibly encode different grids and/or different number of particles into a compressed latent space representation which facilitates scaling to large-scale simulations. Latent space rollouts are enforced by inverse encoding and decoding surrogates, leading to fast simulated trajectories which is particularly important for large systems. For decoding, the latent representation can be evaluated at any point in space-time. UPTs operate without grid-or particle-based latent structures and demonstrate the beneficial scaling-behavior of transformer backbone architectures.

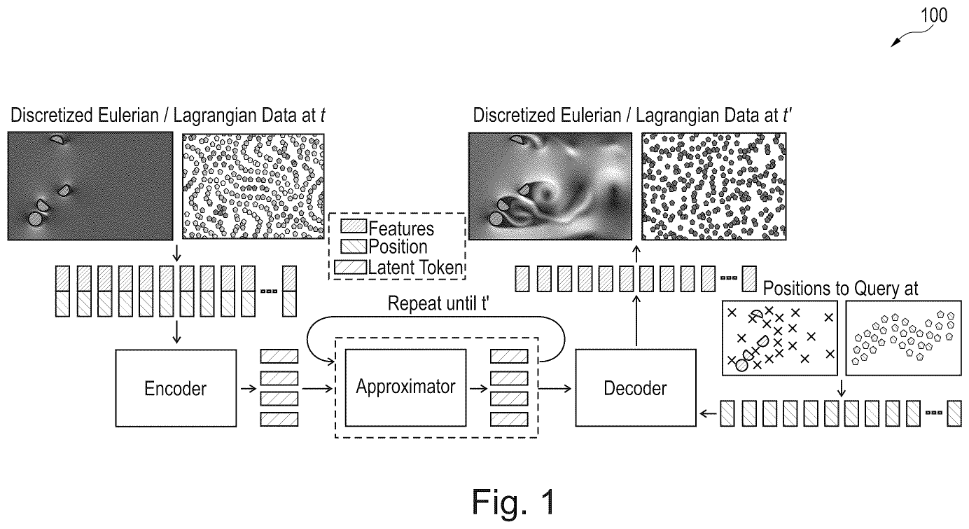

FIG. 1 illustrates a schematic overview of a UPT modeling paradigm in accordance with certain embodiments. As can be seen, UPTs can flexibly encode different grids and/or different number of particles into a unified latent space representation, and subsequently unroll dynamics in the latent space. In certain embodiments, the latent space is kept at a fixed size to ensure scalability to larger systems. UPTs can decode the latent representation at any query point.

### BACKGROUND

Certain concepts underlying certain embodiments of the invention will be described in the following:

Partial differential equations (PDEs). Certain embodiments may operate on (systems of)

PDEs that evolve a signal u(t, x)=u^{t}(x) ∈ [symbol] in a single temporal dimension t ∈ [0, T] and m spatial dimensions x ∈ U ⊂ [symbol] , for an open set U. With 1≤l ∈ [symbol] , systems of PDEs of order l can be written as Equation (1):

$$F ( {D}^{l} {u}^{t} ( x ) , … , {D}^{1} {u}^{t} ( x ) , \frac{{\partial }^{l}}{\partial {t}^{l}} {u}^{t} ( x ) , … , \frac{\partial }{\partial t} {u}^{t} ( x ) , {u}^{t} ( x ) , x , t ) = 0 , for x ∈ U , t ∈ [ 0 , T ] , \qquad ( 1 )$$

where F is a mapping to [symbol] , and for i=1, . . . , l, Dⁱ denotes the differential operator mapping to all i-th order partial derivatives of u with respect to the spatial variable x, whereas

$$\frac{{\partial }^{l}}{\partial {t}^{l}}$$

outputs the corresponding time derivative of order i. Any l-times continuously differentiable u:[0, T]×U→ [symbol] fulfilling the relation of Equation (1) is called a classical solution of Equation (1). Also other notions of solvability (e.g. in the sense of weak derivatives or distributions) are possible, which are not discussed here for the sake of simplicity.

Additionally, initial conditions specify u^{t}(x) at time t=0 and boundary conditions B [u^{t}](x) at the boundary of the spatial domain.

Certain embodiments work mostly with the incompressible Navier-Stokes equations (Temam, 2001), which e.g., in two spatial dimensions conserve the velocity flow field u(t, x, y): [0, T]× [symbol] → [symbol] via Equation (2):

$$\frac{\partial u}{\partial t} = - u \cdot ∇ u + μ {∇}^{2} u - ∇ p + f , ∇ \cdot u = 0 , \qquad ( 2 )$$

where u·∇u is the convection, i.e., the rate of change of u along u, u is the viscosity parameter, μ∇²u the viscosity, i.e., the diffusion or net movement of u, ∇p the internal pressure gradient, and f an external force. The constraint ∇·u=0 yields mass conservation of the Navier-Stokes equations.

Operator learning. Operator learning (Lu et al., 2019, 2021; Li et al., 2020b,a; Kovachki et al., 2021) learns a mapping between function spaces, and this concept is often used to approximate solutions of PDEs. Similar to Kovachki et al. (2021), we assume [symbol] , [symbol] to be Banach spaces of functions on compact domains χ⊂ [symbol] or [symbol] ⊂ [symbol] , mapping into [symbol] or [symbol] , respectively. The goal of operator learning is to learn a ground truth operator [symbol] : U→V via an approximation [symbol] : u→V. This is usually done in the vein of supervised learning by i.i.d. sampling input-output pairs, with the notable difference, that in operator learning the spaces sampled from are not finite dimensional. More precisely, with a given data set consisting of N function pairs (uᵢ, vᵢ)=(uᵢ, G(uᵢ))⊂U×V, i=1, . . . , N, we aim to learn [symbol] : U >V, so that G can be approximated in a suitably chosen norm.

In the context of PDEs, G can e.g. be the mapping from an initial condition u(0, x)=u⁰(x) to the solutions u(t, x)=u^{t}(x) of Equation (1) at all times. In the case of classical solutions, if U is bounded, U can then be chosen as a subspace of C(Ū, [symbol] ), the set of continuous functions from domain Ū (the closure of U) mapping to [symbol] , whereas V⊂C([0, T]×Ū, [symbol] ), so that U or V consist of all l-times continuosly differentiable functions on the respective spaces. In case of weak solutions, the associated spaces U and I can be chosen as Sobolev spaces.

A popular approach, that is also followed in certain embodiments, is to approximate G via three maps (Seidman et al., 2022): G≈ [symbol] := [symbol] ○ [symbol] ○ε. The encoder ε: U→ [symbol] takes an input function and maps it to a finite dimensional latent feature representation. For example, ε could embed a continuous function to a chosen hidden dimension [symbol] for a collection of grid points. Next, the approximator [symbol] : [symbol] → [symbol] approximates the action of the operator [symbol] , and the decoder [symbol] decodes the hidden representation, and thus creates the output functions via [symbol] : [symbol] → [symbol] , which in many cases is point-wise evaluated at the output grid or output mesh.

Particle vs. grid-based methods. Often, numerical simulation methods can be classified into two distinct families: particle and grid-based methods. This specification is notably prevalent, for instance, in the field of computational fluid dynamics (CFD), where Lagrangian and Eulerian discretization schemes offer different characteristics dependent on the PDEs. In simpler terms, Eulerian schemes essentially monitor velocities at specific fixed grid points.

These points, represented by a spatially limited number of nodes, control volumes, or cells, serve to discretize the continuous space. This process leads to grid-based or mesh-based representations. In contrast to such grid-and mesh-based representations, in Lagrangian schemes, the discretization is carried out using finitely many material points, often referred to as particles, which move with the local deformation of the continuum. Roughly speaking, there are three families of Lagrangian schemes: discrete element methods (Cundall & Strack, 1979), material point methods (Sulsky et al., 1994; Brackbill & Ruppel, 1986), and smoothed particle hydrodynamics (SPH) (Gingold & Monaghan, 1977; Lucy, 1977; Monaghan, 1992, 2005). In this work, we focus on SPH methods, which approximate the field properties using radial kernel interpolations over adjacent particles at the location of each particle. The strength of SPH lies in its ability to operate without being constrained by connectivity issues, such as meshes. This characteristic proves especially beneficial when simulating systems that undergo significant deformations.

Latent space representation of neural operators. For larger meshes or larger number of particles, memory consumption and inference speed become more and more important. Fourier Neural Operator (FNO) based methods work on regular grids, or learn a mapping to a regular latent grid, e.g., geometry-informed neural operators (GINO) (Li et al., 2023). In three dimensions, the stored Fourier modes have the shape h×nₓ×n_{y}×n_{z}, where h is the hidden size and nₓ, n_{y}, n_{z} are the respective Fourier modes. Similarly, the latent space of CNN-based methods, e.g., Raoni′c et al. (2023); Gupta & Brandstetter (2022), is of shape h×wₓ×w_{y}×w_{z}, where wₓ, w_{y}, w_{z} are the respective grid points. In three dimension, the memory requirement in each layer increases cubically with increasing number of modes or grid points. In contrast, transformer based neural operators, e.g., Hao et al. (2023); Cao (2021); Li et al. (2022), operate on a token-based latent space of dimension nₜₒₖₑₙₛ×h, where usually nₜₒₖₑₙₛ∝Nₚₒᵢₙₜₛ, and GNN based neural operators, e.g., Li et al. (2020b), operate on a node based latent space of dimension n_{nodes}×h, where usually n_{nodes}=nₚₒᵢₙₜₛ.

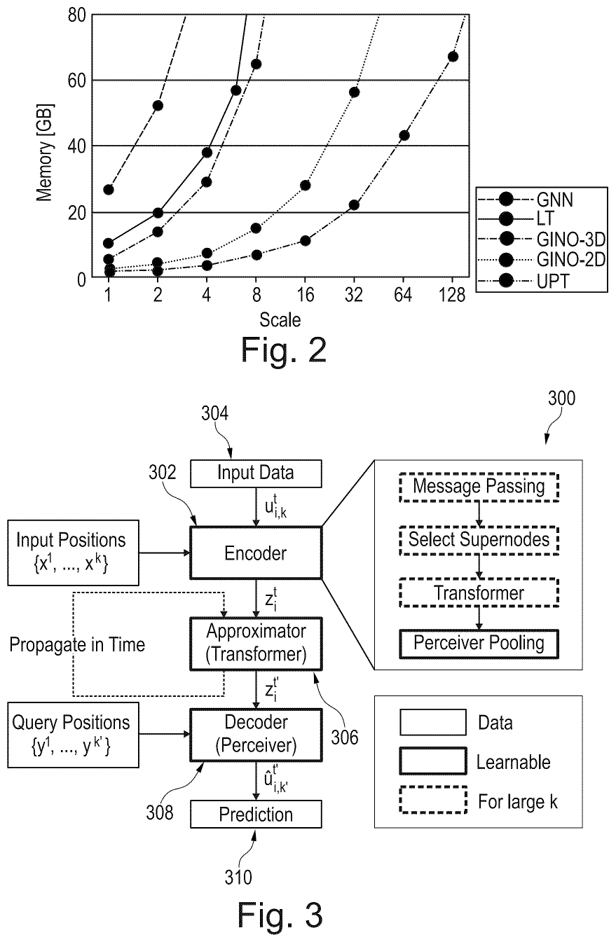

For large number of inputs, this becomes infeasible as every layer has to process a large number of tokens. Contrary, UPTs compress the inputs into a low-dimensional latent space, which drastically decreases computational requirements. Different architectures are compared in the following table. As it can be hard to imagine the practical relevance of theoretical complexity measures, we qualitatively study the scaling limits of representative models in FIG. 2 where we find the efficient latent space compression of UPTs allows training on up to 4.2M input points which is 64× the amount that a GNN could handle.

| | | | Irregular | Discretization | Learns | Latent |
|---|---|---|---|---|---|---|
| Model | Range | Complexity | Grid | Convergent | Field | Rollout |
| GNN | local | O(MD) | ✓ | X | X | X |
| CNN | local | O(G) | X | X | X | X |
| Transformer | global | O(M²) | ✓ | ✓ | X | X |
| Linear | global | O(M) | ✓ | ✓ | X | X |
| Transformer | | | | | | |
| GNO (Li et al., | radius | O(MD) | ✓ | ✓ | X | X |
| 2020b) | | | | | | |
| FNO (Li et al., | global | O(G logG) | X | ✓ | X | X |
| 2020a) | | | | | | |
| GINO (Li et al., | global | O(GD + G logG) | ✓ | ✓ | ✓ | X |
| 2023) | | | | | | |
| UPT (with GNO) | global | O(SD + S²) | ✓ | ✓ | ✓ | ✓ |
| UPT (without | global | O(SM + S²) | ✓ | ✓ | ✓ | ✓ |
| GNO) | | | | | | |

Table 1 illustrates the model comparison. Complexity includes number of mesh points M, and maximum degree of the graph D. Grid-based methods project the mesh to G grid points. UPTs instead use a small amount of supernodes S as discretization, where G is typically much larger than S. The UPT training procedure separates responsibilities between components, allowing to forward-propage dynamics purely within the latent space. For large meshes, UPT may use a GNO to compress the mesh points into supernodes (“with GNO”), which can be omitted for small meshes (“without GNO”).

### Universal Physics Transformers

Generally speaking, a goal underlying certain embodiments of the invention is to learn a mapping between the solutions u^{t} and u^{t}′ of Equation (1) at timesteps t and t′, respectively. The dataset should comprise, or preferably consist of, N function pairs

$$( {u}_{i}^{t} , {u}_{i}^{t ′} ) , i = 1 , … , N ,$$

where each

$${u}_{i}^{t}$$

is sampled at k spatial locations

$$\{ {x}_{i}^{1} , … , {x}_{i}^{k} \} ∈ U .$$

Similarly, we query each output signal

$${\hat{u}}_{i}^{t ′}$$

at k′ spatial locations

$$\{ {y}_{i}^{1} , … , {y}_{i}^{k ′} \} ∈ U .$$

Then each input signal can be represented by

$${u}_{i , k}^{t} = {( {u}_{i}^{t} ( {x}_{i}^{1} ) , … , {u}_{i}^{t} ( {x}_{i}^{k} ) )}^{T}$$

∈ [symbol] as a tensor of shape k×d, similar for the output. For particle- or mesh-based inputs, it is often simpler to represent the input as graph [symbol] =(V, E) with k nodes

$$\{ {x}_{i}^{1} , … , {x}_{i}^{k} \} ∈ V ,$$

edges E (That reflect the neighborhood structure) and node features

$$\{ {u}_{i}^{t} ( {x}_{i}^{1} ) , … , {u}_{i}^{t} ( {x}_{i}^{k} ) \} .$$

An exemplary embodiment of a Universal Physics Transformer 300 is illustrated in FIG. 3. As can be seen, the Universal Physics Transformer 300 comprises an encoder 302, an approximator 306 and a decoder 308, each of which will be described in the following.

The encoder 302 flexibly encodes input data 304, e.g., different grids and/or different number of particles, into a unified latent representation of shape nₗₐₜₑₙₜ×h, where nₗₐₜₑₙₜ is the chosen number of tokens in the latent space and h is the hidden dimension. The goal of the encoder 302 is to compress the input signal 304

$${u}_{i}^{t} ,$$

which is represented by a point cloud [symbol] . Importantly, the encoder 302 should learn to selectively focus on important parts of the input. This is a desirable property as, for example, in many computational fluid dynamics simulations large areas are characterized by laminar flows, whereas turbulent flows tend to occur especially around obstacles. If k is large, a hierarchical encoder may be employed.

In certain embodiments, the encoder 302 first embeds k points into hidden dimension h, adding position encoding (Vaswani et al., 2017) to the different nodes, I.e.,

$${u}_{i , k}^{t}$$

∈ [symbol] → [symbol]
In the first hierarchy, information is exchanged between local points and a selected set of nₛ supernode points. For Eulerian discretization schemes those supernodes can either be uniformly sampled on a regular grid as in Li et al. (2023), or selected based on the given mesh. The latter has the advantage that mesh characteristics are automatically taken into account, e.g., dense or sparse mesh regions are represented by different numbers of nodes. Furthermore, adaptation to new meshes is straightforward. The first hierarchy may be implemented by randomly selecting nₛ supernodes on the mesh, choosing nₛ such that the mesh characteristic is preserved. E.g., for experiments presented elsewhere herein, nₛ=2048. Similarly, in the Lagrangian discretization scheme, choosing supernodes based on particle positions provides the same advantages as selecting them based on the mesh.

In certain embodiments, information is aggregated at the selected nₛ supernodes via a message passing layer (Gilmer et al., 2017) using a radius graph between points. Importantly, messages only flow towards the nₛ supernodes, and thus the compute complexity of the first hierarchy scales linearly with nₛ. The second hierarchy consists of transformer blocks (Vaswani et al., 2017) followed by a perceiver block (Jaegle et al., 2021b,a) with nₗₐₜₑₙₜ learned queries of dimension h. To summarize, the encoder 302 ε maps

$${u}_{i}^{t}$$

∈ [symbol] to a latent space via

$$ℰ : {u}_{i}^{t} ∈ 𝒰 {\to }^{evaluate} {u}_{i . k}^{t} ∈ {ℝ}^{k \times d} {\to }^{embed} {ℝ}^{k \times h} {\to }^{MP} {ℝ}^{{n}_{s} \times h} {\to }^{transformer} {ℝ}^{{n}_{s} \times h} {\to }^{perceiver} {z}_{i}^{t} ∈ {ℝ}^{{n}_{latent} \times h} ,$$

where typically nₗₐₜₑₙₜ «nₛ«k. If the number of points is manageable, the first hierarchy can be omitted.

Referring back to FIG. 3, the Universal Physics Transformer 300 of the illustrated embodiment further comprises an approximator 306. The approximator 306 and a corresponding training procedure allows to forward-propagate dynamics purely within the latent space without mapping back to the spatial domain at each operator step. The approximator 306 propagates the compressed representation forward in time. As nₗₐₜₑₙₜ IS small, forward propagation in time is fast. In certain embodiments, a stack of transformer blocks is employed as approximator 306 [symbol] .

$$𝒜 : {z}_{i}^{t} ∈ {ℝ}^{{n}_{latent} \times h} \to {z}_{i}^{t ′} ∈ {ℝ}^{{n}_{latent} \times h} .$$

Notably, the approximator 306 can be applied multiple times, propagating the input signal 304 forward in time by Δt each time. If Δt is small enough, the input signal 304 can be approximated at arbitrary future times t′.

Again referring to FIG. 3, the Universal Physics Transformer 300 of the illustrated embodiment further comprises a decoder 308. The decoder 308 is configured to query the latent representation at different locations. The task of the decoder 308 [symbol] is to query the latent representation at k′ arbitrary locations to construct the prediction of the output signal

$${u}_{i}^{t ′}$$

310 at time t′. More formally, given the output positions

$$\{ {y}_{i}^{1} , … , {y}_{i}^{k ′} \}$$

locations and the latent representation

$${z}_{i}^{t ′} ,$$

the decoder 308 predicts the output signal 310

$${u}_{i , k ′}^{t ′} = {( {u}_{i}^{t ′} ( {y}_{i}^{1} ) , … , {u}_{i}^{t ′} ( {y}_{i}^{k ′} ) )}^{T}$$

at these spatial locations at timestep t′.output signal 310

$$𝒟 : ( {z}_{i}^{t ′} , \{ {y}_{i}^{1} , … , {y}_{i}^{k ′} \} ) \to {u}_{i , k ′}^{t ′} ∈ {ℝ}^{{k}^{′} \times d} .$$

In certain embodiments, the decoder 308 is implemented via a perceiver-like cross attention layer using a positional embedding of the output positions as query and the latent representation

$${z}_{i}^{t ′}$$

as keys and values. Since there is no interaction between queries, the latent representation can be queried at arbitrarily many positions without large computational overhead. This decoding mechanism establishes a connection of conditioned neural fields to operator learning (Perdikaris, 2023).

In summary, and as can be seen in FIG. 3, the encoder 302 compresses information from various grids or differing particles. Subsequently, this information is propagated forward in time through the approximator 306 and decoded by the decoder 308 at arbitrary query positions.

Certain embodiments of the invention may comprise a model conditioning functionality which will be described in the following. To condition the model to the current timestep t and to boundary conditions such as the inflow velocity, feature modulation can be added to all transformer and perceiver blocks. We DiT modulation (Peebles & Xie, 2023) may be used, which consists of a dimension-wise scale, shift and gate operation that are applied to the attention and MLP module of the transformer. Scale, shift and gate are dependent on an embedding of the timestep and boundary conditions (e.g. velocity).

Certain embodiments of the invention may comprise a training procedure which will be described in the following. In some embodiments, Universal Physics Transformers model the dynamics fully within a latent representation, such that during inference only the initial state of the system u(0, x)=u⁰(x) is encoded into a latent representation z⁰. From there on, instead of autoregressively feeding the decoder's prediction into the encoder, Universal Physics Transformers propagate z⁰ forward in time to z^{t′} through iteratively applying the approximator [symbol] in the latent space, a procedure also referred to as latent rollout. Especially for large meshes or many particles, the benefits of latent space rollouts, i.e. fast inference, pays off.

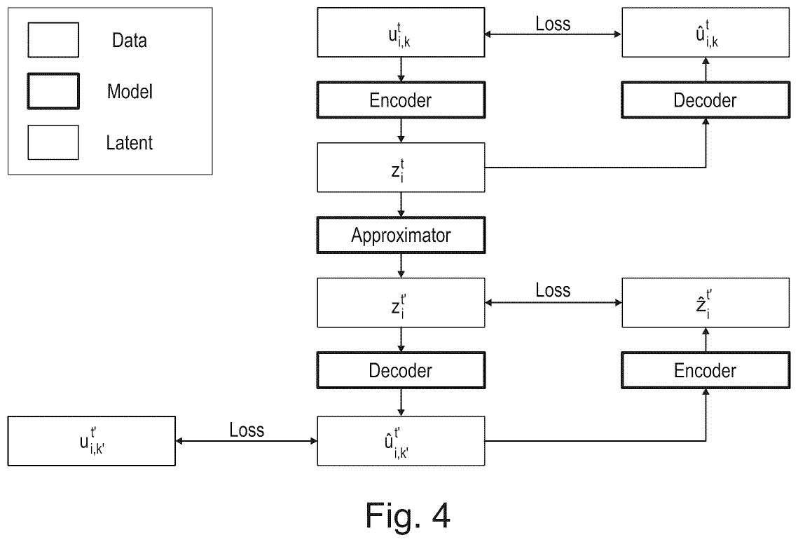

In certain embodiments, to enable latent rollouts, the responsibilities of encoder 302 ε, approximator 306 [symbol] and decoder 308 [symbol] are isolated. In this case, the encoding and decoding are inverted by means of two reconstruction losses during training as visualized in FIG. 4. First, an inverse encoding is performed, wherein the input

$${u}_{i}^{t}$$

is reconstructed from the encoded latent state

$${z}_{i}^{t}$$

by querying it with the decoder at k input locations

$$\{ {x}_{i}^{1} , … , {x}_{i}^{k} \} .$$

Second, the decoding is inverted by reconstructing the latent state

$${z}_{i}^{t ′}$$

from the output signal

$${\hat{u}}_{i}^{t ′}$$

at k′ spatial locations

$$\{ {y}_{i}^{1} , … , {y}_{i}^{k ′} \}$$

Using two reconstruction losses, the encoder is forced to focus on encoding a state uᵢ^{t} into a latent representation z^{t}, and similarly the decoder is forced to focus on making predictions out of a latent representation z^{t′}.

One related work are the transformer neural operators of Cao (2021); Li et al. (2022); Hao et al. (2023) which encode different query points into a tokenized latent space representation of dimension n_{nodes}×h, where n_{nodes} varies based on the number of input points, i.e., n_{nodes}×Nₚₒᵢₙₜₛ. Wu et al. (2024) adds a learnable mapping into a fixed latent space of dimension n_{nodes}×h to each transformer layer, and projects back to dimension nₚₒᵢₙₜₛ×h after self-attention. In contrast, Universal Physics Transformers according to certain embodiments use fixed nₗₐₜₑₙₜ for the unified latent space representation nₗₐₜₑₙₜ×h.

For the modeling of temporal PDEs, a common scheme is to map the input solution at time t to the solution at next time step t′ (Li et al., 2020a; Brandstetter et al., 2022a; Takamoto et al., 2022). Especially for systems that are modeled by graph-based representations, predicted accelerations at nodes are numerically integrated to model the time evolution of the system (Sanchez-Gonzalez et al., 2020; Pfaff et al., 2020). Recently, equivariant graph neural operators (Xu et al., 2024) were introduced which model time evolution via temporal convolutions in Fourier space. More related are methods that propagate dynamics in the latent space (Lee & Carlberg, 2021; Wiewel et al., 2019). Once the system is encoded, time evolution is modeled via LSTMs (Wiewel et al., 2019), or even linear propagators (Lusch et al., 2018; Morton et al., 2018). In Li et al. (2022), attention-based layers are used for encoding the spatial information of the input and query points, while time updates in the latent space are performed using recurrent MLPs. Similarly, Bryutkin et al. (2024) use recurrent MLPs for temporal updates within the latent space, while utilizing a graph transformer for encoding the input observations.

Recent works relating to universal models and foundation models comprise pretraining over multiple heterogeneous physical systems, mostly in the form of PDEs (McCabe et al., 2023), foundation models for weather and climate (Nguyen et al., 2023), or material modeling (Merchant et al., 2023; Zeni et al., 2023; Batatia et al., 2022).

Methods relating to latent space modeling have been proposed in the context of diffusion models (Rombach et al., 2022) where a pre-trained compression model is used to compress the input into a latent space from which a diffusion model can be trained at much lower costs.

Certain embodiments of Universal Physics Transformers also compress the high-dimensional input into a low-dimensional latent space, but without relying on a two stage approach. Instead, certain embodiments learn the compression end-to-end via inverse encoding and decoding techniques.

### Experiments

In the following, several experiments which have been performed on embodiments of the invention will be described. The experiments were run across different settings, assessing three key aspects of Universal Physics Transformers: (i) Effectiveness of the latent space representation. We test on steady state flow simulations in three dimensions, comparing against methods that use regular grid representations, and thus considerably larger latent space representations. (ii) Scalability. We test on transient flow simulations on large meshes. Specifically, we test the effectiveness of latent space rollouts, and assess how well Universal Physics Transformers generalize across different flow regime, and different domains, i.e., different number of mesh points and obstacles. (iii) Lagrangian dynamics modeling. Finally, we assess how well Universal Physics Transformers model underlying field characteristics when applied to particle-based simulations.

### Steady State Flows

For steady state prediction, we consider the dataset generated by Umetani & Bickel (2018), which we denote as ShapeNet-Car. It consists of 889 car shapes from ShapeNet (Chang et al., 2015), where each car surface is represented by 3.6K mesh points in 3D space. Umetani & Bickel (2018) simulated 10 seconds of air flow and averaged the results over the last 4 seconds. The inflow velocity is fixed at 20 m/s with an estimated Reynolds Number of Re=5×10⁶. Following GINO (Li et al., 2023), we randomly split the data into 700 training samples and 189 test samples. We regress the pressure at each surface point with a mean-squared error (MSE) loss and sweep hyperparameters per model. Note that due to the small scale of this dataset, we train the largest possible model that is able to generalize the best. Training even larger models resulted in a performance decrease due to overfitting. We optimize the model size for all methods where the best mesh-based models (GINO, UPT) contain around 300M parameters. The best regular grid-based models (U-Net (Ronneberger et al., 2015; Gupta & Brandstetter, 2022), FNO (Li et al., 2020a)) are significantly smaller and range from 15M to 100M.

In GINO, feature engineering in the form of a signed distance function (SDF) is used in addition to the mesh points to represent the irregular mesh as a regular grid. To include these features into Universal Physics Transformers, we encode them into 8³=512 latent SDF tokens using a shallow ConvNext V2 (Woo et al., 2023). These SDF tokens are concatenated to the latent tokens produced by the encoder and then fed to the approximator. When using the SDF features, we chose nₗₐₜₑₙₜ=1024 to balance the number of tokens from the mesh with the number of SDF tokens. Without SDF tokens, a much smaller number of tokens (64) is used.

ShapeNet-Car is a small-scale dataset. Consequently, methods that map the mesh onto a regular grid can employ grids of extremely high resolution, such that the number of grid points is orders of magnitude higher than the number of mesh points. For example, a grid resolution of 64 points per spatial dimension results in 262.114 grid points, which is 73× the number of mesh points. As Universal Physics Transformer is designed to operate directly on the mesh, we compare at different grid resolutions. The results in the following table demonstrate that Universal Physics Transformer (UPT) can model the underlying dynamics with a fraction of latent tokens and performs best across all grid sizes except at the highest resolution of 643 where GINO performs slightly better:

| Model | SDF | #Tokens | MSE | Mem. [GB] |
|---|---|---|---|---|
| U-Net | 0 | 64³ | 6.13 | 1.3 |
| FNO | 0 | 64³ | 4.04 | 3.8 |
| GINO | 0 | 64³ | 2.34 | 19.8 |
| UPT | 0 | 64 | 2.31 | 0.6 |
| U-Net | 32 | 32³ | 3.66 | 0.2 |
| FNO | 32 | 32³ | 3.31 | 0.5 |
| GINO | 32 | 32³ | 2.90 | 2.1 |
| UPT | 32 | 8³ + 1024 | 2.35 | 2.7 |
| U-Net | 64 | 64³ | 2.83 | 1.3 |
| FNO | 64 | 64³ | 3.26 | 3.8 |
| GINO | 64 | 64³ | 2.14 | 19.8 |
| UPT | 64 | 8³ + 1024 | 2.24 | 2.7 |

The table above shows a normalized test MSE for ShapeNet-Car pressure prediction. The loss is multiplied by 100. Memory denotes the amount required for a forward and backward pass of a single sample. UPTs can model the dynamics with a fraction of latent tokens compared to other models.

### Transient Flows

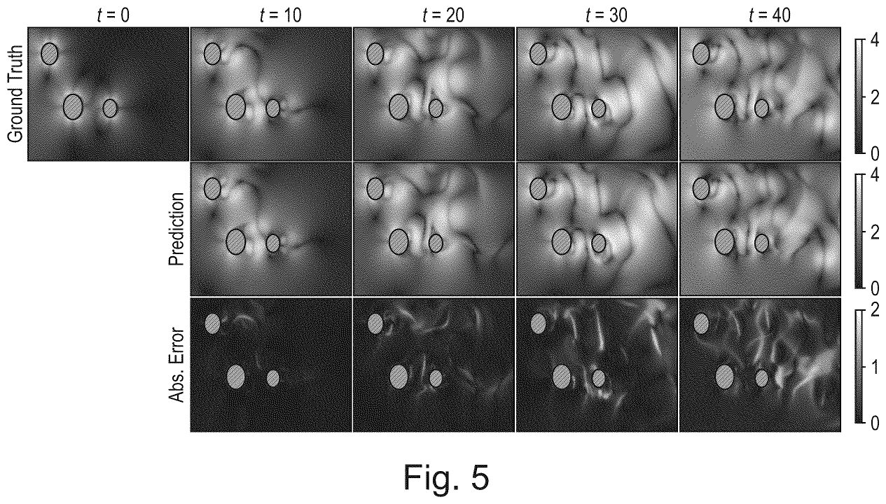

FIG. 5 illustrates example rollout trajectories of the UPT-68M model, visually demonstrating the efficacy of UPT physics modeling. The UPT model is trained across different obstacles, different flow regimes, and different mesh discretizations. Interestingly, the absolute error might suggest that UPT trajectories diverge, although physics are still simulated faithfully. This stems from subtle shifts in predictions throughout the rollout duration, likely attributed to the point-wise decoding of the latent field.

We test the scalability of Universal Physics Transformers on large-scale transient flow simulations. For this purpose, we self-generate 10K Navier-Stokes simulations within a pipe flow, which we split into 8K training, 1K validation and 1K test trajectories, using the pisoFoam solver from OpenFOAM (Weller et al., 1998). For each simulation, between one and four objects (circles of variable size) are placed randomly within the pipe flow, and the uni-directional inflow velocity varies between 0.01 to 0.06 m/s. The temporal update of the numerical solver is initially set to Δt=0.05s. If instabilities occur, the trajectory is rerun with smaller Δt. Overall, each trajectory comprises 2K timesteps at the coarsest Δt setting and 200K at the finest (Δt=0.0005s). After every second of simulated time, the corresponding timestep is written to the disk, resulting in 100 stored timesteps per trajectory. Each simulation contains between 29K and 59K mesh points where each point has three features: pressure, and the x- and y-component of the velocity. A single simulation takes on average 120 seconds on 16 CPUs. In total, the dataset amounts to approximately 235 GB of data in float16 precision.

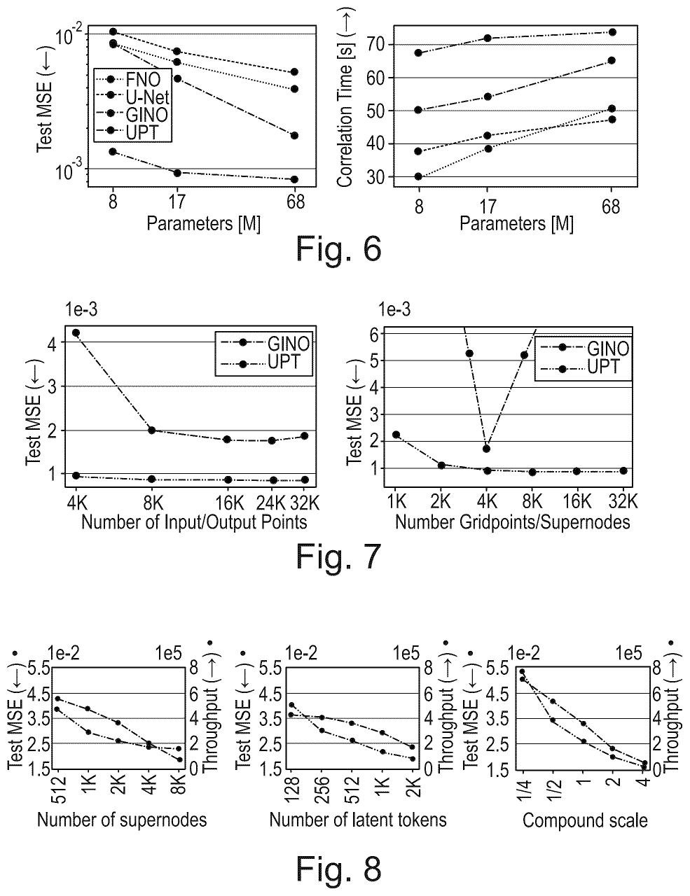

Model-wise, UPT uses the hierarchical encoder setup with all optional components depicted in FIG. 3. A message passing layer aggregates local information into nₛ=2048 randomly selected supernodes, a transformer processes the supernodes and a perceiver pools the supernodes into nₗₐₜₑₙₜ=512 latent tokens. Approximator and decoder are unchanged. In FIG. 6, we compare UPT against GINO, U-Net and FNO. For U-Net and FNO, we interpolate the mesh onto a regular grid. We condition the models onto the current timestep and inflow velocity by modulating features within the model. We employ FILM conditioning for U-Net (Perez et al., 2018), the “Spatial-Spectral” conditioning method introduced in Gupta & Brandstetter (2022) for FNO and GINO, and DiT for UPT (Peebles & Xie, 2023).

We train all models for 100 epochs and evaluate test MSE as well as rollout performance for which we use the number of timesteps until the Pearson correlation of the rollout drops below 0.8 as evaluation metric (Kochkov et al., 2021). We do not employ any additional techniques to stabilize rollouts, see e.g., Lippe et al. (2024). FIG. 6 shows that UPTs outperform compared methods on all model scales by a large margin. For all architectures, we didn't observe much performance increase when further increasing parameter count, but rather observe that computation gets quickly infeasible with our current computational resources (UPT-68M and GINO-68M training takes roughly 450 A100 hours). The smaller variants UPT-8M and UPT-17M take roughly 150 and 200 A 100 hours, respectively.

While one would ideally use lots of supernodes and query the latent space with all positions during training, increasing those quantities increases training costs and the performance gains saturate. Therefore, we only use 2.048 supernodes and 16K randomly selected query positions during training. We investigate discretization convergence in the right part of FIG. 7 where we vary the number of input/output points and the number of supernodes. We use the 68M models without any retraining, i.e., we test models on “discretization convergence” as, during training, the mesh was discretized into 2.048 supernodes and 16K query positions. UPT generalizes across a wide range of different number of input or output positions, with even slight performance increases when using more input points. Similarly, using more supernodes increases performance slightly.

As training with larger latent spaces becomes expensive, we investigate it in a reduced setting where we train for only 10 epochs and fix the number of input points to 16K. The results in FIG. 8 show that UPTs scale well with larger latent spaces, allowing a flexible compute-performance tradeoff.

Finally, we evaluate training with inverse encoding and decoding techniques, see FIG. 4. We investigate the impact of the latent rollout by training our largest model—a 68M UPT. The latent rollout achieves on par results to autoregressively unrolling via the physics domain but speeds up the inference speed significantly as shown in the following table. However, it is to note that in its current implementation the latent rollout requires a non-negligible overhead during training while greatly reducing costs and speed in inference.

| | Time on 16 | | Time on 1 | |
|---|---|---|---|---|
| Model | CPUs | | GPU | Speedup |
| pisoFoam | 120 | s | — | 1x |
| GINO-68M (autoreg.) | 48 | s | 1.2 s | 100x |
| UPT-68M (autoreg.) | 46 | s | 2.0 s | 60x |
| UPT-68M (latent) | 3 | s | 0.3 s | 400x |

The table above shows the tequired time to simulate a full trajectory rollout. UPT and GINO are orders of magnitude faster than traditional finite volume solvers. The latent rollout is additionally more than 5× faster than an autoregressive rollout via the physics domain. Neural surrogate models are also faster on CPUs as traditional solvers require extremely small timescales to remain stable (Δt≤0.05 vs. Δt=1).

### Lagrangian Fluid Dynamics

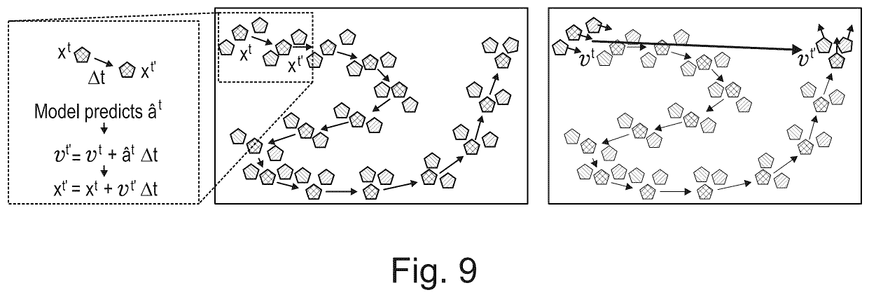

Scaling particle-based methods such as discrete element methods or smoothed particle hydrodynamics to 10 million or more particles presents a significant challenge (Yang et al., 2020; Blais et al., 2019), yet it also opens a distinctive opportunity for neural surrogates. Such systems are far beyond the scope of this work. We however present a framing of how to model such systems via UPTs such that the studied scaling properties of UPTs could be exploited. In order to do so, we demonstrate how UPTs capture inherent field characteristics when applied to Lagrangian SPH simulations, as provided in LagrangeBench (Toshev et al., 2023b). Here, GNNs, such as Graph Network-based Simulators (GNS) (Sanchez-Gonzalez et al., 2020) and Steerable E(3) Equivariant Graph Neural Networks (SEGNNs) (Brandstetter et al., 2022b) are strong baselines, where predicted accelerations at the nodes are numerically integrated to model the time evolution of the particles. In contrast, UPTs learn underlying dynamics without dedicated particle-structures, and propagate dynamics forward without the guidance of numerical time integration schemes. An overview of the conceptual differences between GNS/SEGNN and UPTs is shown in FIG. 9.

We use the Taylor-Green Vortex dataset in two and three dimensions (TGV2D, TGV3D). The Taylor-Green vortex (TGV) system was introduced by Taylor & Green (1937) as test scenario for turbulence modeling. The TGV system is an unsteady flow of a decaying vortex, displaying an exact closed form solution of the incompressible Navier-Stokes equations in Cartesian coordinates. We note that the TGV2D and TGV3D datasets model the same trajectory, however with different particles. Formulating the TGV system as UPT learning problem therefore means that the same trajectory is queried at different positions. Consequently, the evaluation against GNN-based simulators should be viewed as an illustration of the efficacy of UPTs in learning field characteristics, rather than a comprehensive GNN versus UPT comparison.

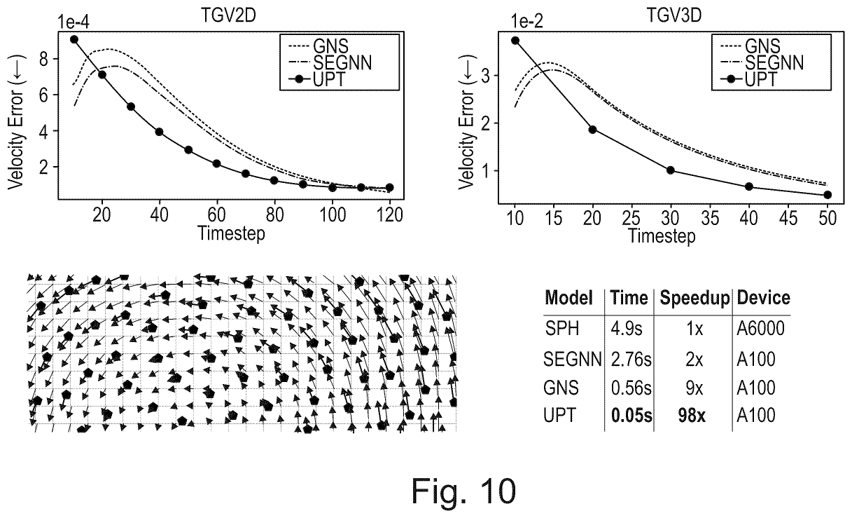

For UPT training, we input two consecutive velocities of the particles in the dataset at timesteps t and t−1, and the respective particle positions. We regress two consecutive velocities at a later timesteps {t′−1, t}={t+ΔT−1, t+AT} with mean-squared error (MSE) objective. For all experiments we use ΔT=10Δt. The flexibility of the UPT encoder allows us to randomly sample 50% up to 100% of the total particles, diversifying the training procedure and forcing the model to learn the underlying dynamics. For both inverse encoding and decoding losses we use the velocities of all particles. We query the decoder to output velocities at target positions. UPTs encode the first two velocities of a trajectory, and autoregressively propagate dynamics forward in the latent space. We report the Euclidean norm of velocity differences across all k particles. FIG. 10 compares the rollout performance of GNS, SEGNN and UPT and shows the speedup of both methods compared to the SPH solver. The results demonstrate that UPTs effectively learn the underlying field dynamics while also managing much faster rollouts, with a 98-fold speedup compared to the SPH solver, a 55-fold speedup compared to SEGNN and a 11-fold speedup compared to GNS.

### CONCLUSION

We have introduced the Universal Physics Transformers (UPTs) framework for efficiently scaling neural operators, demonstrating its applicability to a wide range of spatio-temporal problems. UPTs operate without grid- or particle-based latent structures, enabling flexibility across meshes and number of particles. The UPT training procedure separates responsibilities between components, allowing a forward propagation in time purely within the latent space. Finally, UPTs allow for queries of the latent space representation at any point in space-time.

### REFERENCES

Andrychowicz, M., Espeholt, L., Li, D., Merchant, S., Merose, A., Zyda, F., Agrawal, S., and Kalchbrenner, N. Deep learning for day forecasts from sparse observations. arXiv preprint arXiv: 2306.06079, 2023.
Bartels, S. Numerical Approximation of Partial Differential Equations. Springer, 2016.
Batatia, I., Kovacs, D. P., Simm, G., Ortner, C., and Cs′anyi, G. Mace: Higher order equivariant message passing neural networks for fast and accurate force fields. Advances in Neural Information Processing Systems, 35:11423-11436, 2022.
Battaglia, P., Pascanu, R., Lai, M., Jimenez Rezende, D., et al. Interaction networks for learning about objects, relations and physics. Advances in neural information processing systems, 29, 2016.
Battaglia, P. W., Hamrick, J. B., Bapst, V., Sanchez-Gonzalez, A., Zambaldi, V., Malinowski, M., Tacchetti, A., Raposo, D., Santoro, A., Faulkner, R., et al. Relational inductive biases, deep learning, and graph networks. arXiv preprint arXiv: 1806.01261, 2018.
Batzner, S., Musaelian, A., Sun, L., Geiger, M., Mailoa, J. P., Kornbluth, M., Molinari, N., Smidt, T. E., and Kozinsky, B. E (3)-equivariant graph neural networks for data-efficient and accurate interatomic potentials. Nature communications, 13 (1): 2453, 2022.
Bi, K., Xie, L., Zhang, H., Chen, X., Gu, X., and Tian, Q. Pangu-weather: A 3d high-resolution model for fast and accurate global weather forecast. arXiv preprint arXiv: 2211.02556, 2022.
Blais, B., Vidal, D., Bertrand, F., Patience, G. S., and Chaouki, J. Experimental methods in chemical engineering: Discrete element method-dem. The Canadian Journal of Chemical Engineering, 97 (7): 1964-1973, 2019.
Bommasani, R., Hudson, D. A., Adeli, E., Altman, R., Arora, S., von Arx, S., Bernstein, M. S., Bohg, J., Bosselut, A., Brunskill, E., Brynjolfsson, E., Buch, S., Card, D., Castellon, R., Chatterji, N. S., Chen, A. S., Creel, K. A., Davis, J., Demszky, D., Donahue, C., Doumbouya, M., Durmus, E., Ermon, S., Etchemendy, J., Ethayarajh, K., Fei-Fei, L., Finn, C., Gale, T., Gillespie, L. E., Goel, K., Goodman, N. D., Grossman, S., Guha, N., Hashimoto, T., Henderson, P., Hewitt, J., Ho, D. E., Hong, J., Hsu, K., Huang, J., Icard, T. F., Jain, S., Jurafsky, D., Kalluri, P., Karamcheti, S., Keeling, G., Khani, F., Khattab, O., Koh, P.W., Krass, M. S., Krishna, R., Kuditipudi, R., Kumar, A., Ladhak, F., Lee, M., Lee, T., Leskovec, J., Levent, I., Li, X. L., Li, X., Ma, T., Malik, A., Manning, C. D., Mirchandani, S. P., Mitchell, E., Munyikwa, Z., Nair, S., Narayan, A., Narayanan, D., Newman, B., Nie, A., Niebles, J. C., Nilforoshan, H., Nyarko, J. F., Ogut, G., Orr, L., Papadimitriou, I., Park, J. S., Piech, C., Portelance, E., Potts, C., Raghunathan, A., Reich, R., Ren, H., Rong, F., Roohani, Y. H., Ruiz, C., Ryan, J., R′e, C., Sadigh, D., Sagawa, S., Santhanam, K., Shih, A., Srinivasan, K. P., Tamkin, A., Taori, R., Thomas, A. W., Tram er, F., Wang, R. E., Wang, W., Wu, B., Wu, J., Wu, Y., Xie, S. M., Yasunaga, M., You, J., Zaharia, M. A., Zhang, M., Zhang, T., Zhang, X., Zhang, Y., Zheng, L., Zhou, K., and Liang, P. On the opportunities and risks of foundation models. ArXiv, 2021. URL https://crfm.stanford.edu/assets/report.pdf.
Boussinesq, J. V. Essai sur 1a théorie des eaux courantes. Mémoires présentés par divers savants à l′Académie des Sciences, 23, 1877.
Brackbill, J. U. and Ruppel, H. M. Flip: A method for adaptively zoned, particle-in-cell calculations of fluid flows in two dimensions. Journal of Computational physics, 65 (2): 314-343, 1986.
Brandstetter, J., Berg, R. v. d., Welling, M., and Gupta, J. K. Clifford neural layers for pde modeling. arXiv preprint arXiv: 2209.04934, 2022a.
Brandstetter, J., Hesselink, R., van der Pol, E., Bekkers, E. J., and Welling, M. Geometric and physical quantities improve e (3) equivariant message passing. In International Conference on Learning Representations, 2022b.
Brandstetter, J., Worrall, D., and Welling, M. Message passing neural pde solvers. arXiv preprint arXiv: 2202.03376, 2022c.
Bryutkin, A., Huang, J., Deng, Z., Yang, G., Sch\ddot{ }onlieb, C.-B., and Aviles-Rivero, A. Hamlet: Graph transformer neural operator for partial differential equations. arXiv preprint arXiv: 2402.03541, 2024.
Cao, S. Choose a transformer: Fourier or galerkin. Advances in neural information processing systems, 34:24924-24940, 2021.
Carey, N., Zanisi, L., Pamela, S., Gopakumar, V., Omotani, J., Buchanan, J., and Brandstetter, J. Data efficiency and long term prediction capabilities for neural operator surrogate models of core and edge plasma codes. arXiv preprint arXiv: 2402.08561, 2024.
Chang, A. X., Funkhouser, T. A., Guibas, L. J., Hanrahan, P., Huang, Q., Li, Z., Savarese, S., Savva, M., Song, S., Su, H., Xiao, J., Yi, L., and Yu, F. Shapenet: An information-rich 3d model repository. CoRR, abs/1512.03012, 2015.
Chen, X., Liang, C., Huang, D., Real, E., Wang, K., Liu, Y., Pham, H., Dong, X., Luong, T., Hsieh, C., Lu, Y., and Le, Q. V. Symbolic discovery of optimization algorithms. CoRR, abs/2302.06675, 2023.
Colagrossi, A. and Maurizio, L. Numerical simulation of interfacial flows by smoothed particle hydrodynamics. Journal of Computational Physics, 191, 2003.
Crespo, A., Dominguez, J. M., Barreiro, A., Gomez-Gasteira, M., and D, R. B. Gpus, a new tool of acceleration in cfd: efficiency and reliability on smoothed particle hydrodynamics methods. PLOS ONE, 6, 2011.
Cundall, P. A. and Strack, O. D. A discrete numerical model for granular assemblies. geotechnique, 29 (1): 47-65, 1979.
Devlin, J., Chang, M.-W., Lee, K., and Toutanova, K. Bert: Pre-training of deep bidirectional transformers for language understanding. arXiv preprint arXiv: 1810.04805, 2018.
Dosovitskiy, A., Beyer, L., Kolesnikov, A., Weissenborn, D., Zhai, X., Unterthiner, T., Dehghani, M., Minderer, M., Heigold, G., Gelly, S., Uszkoreit, J., and Houlsby, N. An image is worth 16×16 words: transformers for image recognition at scale. In ICLR. OpenReview.net, 2021.
Gilmer, J., Schoenholz, S. S., Riley, P. F., Vinyals, O., and Dahl, G. E. Neural message passing for quantum chemistry. In International conference on machine learning, pp. 1263-1272. PMLR, 2017.
Gingold, R. A. and Monaghan, J. J. Smoothed particle hydrodynamics: theory and application to non-spherical stars. Monthly notices of the royal astronomical society, 181 (3): 375-389, 1977.
Guo, X., Li, W., and lorio, F. Convolutional neural networks for steady flow approximation. In Proceedings of the 22nd ACM SIGKDD international conference on knowledge discovery and data mining, pp. 481-490, 2016.
Gupta, J. K. and Brandstetter, J. Towards multi-spatiotemporal-scale generalized pde modeling. arXiv preprint arXiv: 2209.15616, 2022.
Hanjalic, K. and Brian, L. A reynolds stress model of turbulence and its application to thin shear flows. Journal of Fluid Mechanics, 52 (4): 609-638, 1972.
Hao, Z., Wang, Z., Su, H., Ying, C., Dong, Y., Liu, S., Cheng, Z., Song, J., and Zhu, J. Gnot: A general neural operator transformer for operator learning. In International Conference on Machine Learning, pp. 12556-12569. PMLR, 2023.
Harada, T., Koshizuka, S., and Kawaguchi, Y. Smoothed particle hydrodynamics on gpus. Computer Graphics International, pp. 63-70, 2007.
He, K., Chen, X., Xie, S., Li, Y., Doll′ar, P., and Girshick, R. Masked autoencoders are scalable vision learners. In IEEE/CVF Conference on Computer Vision and Pattern Recognition (CVPR), pp. 16000-16009, 2022.
Hendrycks, D. and Gimpel, K. Gaussian error linear units (gelus). arXiv preprint arXiv: 1606.08415, 2016.
Issa, R. Solution of the implicitly discretized fluid flow equations by operator-splitting. Journal of Computational Physics, 62, 1986.
Jaegle, A., Borgeaud, S., Alayrac, J.-B., Doersch, C., Ionescu, C., Ding, D., Koppula, S., Zoran, D., Brock, A., Shelhamer, E., et al. Perceiver io: A general architecture for structured inputs & outputs. In International Conference on Learning Representations, 2021a.
Jaegle, A., Gimeno, F., Brock, A., Vinyals, O., Zisserman, A., and Carreira, J. Perceiver: General perception with iterative attention. In International conference on machine learning, pp. 4651-4664. PMLR, 2021b.
Kingma, D. P. and Ba, J. Adam: A method for stochastic optimization. In Bengio, Y. and LeCun, Y. (eds.), 3rd International Conference on Learning Representations, ICLR 2015, San Diego, CA, USA, May 7-9, 2015, Conference Track Proceedings, 2015.
Kipf, T. N. and Welling, M. Semi-supervised classification with graph convolutional networks. In International Conference on Learning Representations, 2017.
Kochkov, D., Smith, J. A., Alieva, A., Wang, Q., Brenner, M. P., and Hoyer, S. Machine learning-accelerated computational fluid dynamics. Proceedings of the National Academy of Sciences, 118 (21): e2101784118, 2021.
Kohl, G., Chen, L.-W., and Thuerey, N. Turbulent flow simulation using autoregressive conditional diffusion models. arXiv preprint arXiv: 2309.01745, 2023.
Kolmogorov, A. N. A refinement of previous hypotheses concerning the local structure of turbulence in a viscous incompressible fluid at high reynolds number. Journal of Fluid Mechanics, 13 (1): 82-85, 1962.
Kolmogorov, A. Local structure of turbulence in an incompressible fluid at very high Reynolds numbers. CR Ad. Sei. UUSR, 30:305, 1941.
Kovachki, N., Li, Z., Liu, B., Azizzadenesheli, K., Bhattacharya, K., Stuart, A., and Anandkumar, A. Neural operator: Learning maps between function spaces. arXiv preprint arXiv: 2108.08481, 2021.
Lam, R., Sanchez-Gonzalez, A., Willson, M., Wirnsberger, P., Fortunato, M., Pritzel, A., Ravuri, S., Ewalds, T., Alet, F., Eaton-Rosen, Z., et al. Graphcast: Learning skillful medium-range global weather forecasting. arXiv preprint arXiv: 2212.12794, 2022.
Lee, K. and Carlberg, K. T. Deep conservation: A latent-dynamics model for exact satisfaction of physical conservation laws. In Proceedings of the AAAI Conference on Artificial Intelligence, volume 35, pp. 277-285, 2021.
Li, Z., Kovachki, N., Azizzadenesheli, K., Liu, B., Bhattacharya, K., Stuart, A., and Anandkumar, A. Fourier neural operator for parametric partial differential equations. arXiv preprint arXiv: 2010.08895, 2020a.
Li, Z., Kovachki, N., Azizzadenesheli, K., Liu, B., Bhattacharya, K., Stuart, A., and Anandkumar, A. Neural operator: Graph kernel network for partial differential equations. arXiv preprint arXiv: 2003.03485, 2020b.
Li, Z., Meidani, K., and Farimani, A. B. Transformer for partial differential equations' operator learning. arXiv preprint arXiv: 2205.13671, 2022.
Li, Z., Kovachki, N. B., Choy, C., Li, B., Kossaifi, J., Otta, S. P., Nabian, M. A., Stadler, M., Hundt, C., Azizzadenesheli, K., et al. Geometry-informed neural operator for large-scale 3d pdes. arXiv preprint arXiv: 2309.00583, 2023.
Li, Z., Patil, S., Ogoke, F., Shu, D., Zhen, W., Schneier, M., Jr., J. R. B., and Farimani, A. B. Latent neural PDE solver: a reduced-order modelling framework for partial differential equations. CoRR, abs/2402.17853, 2024.
Lienen, M., Hansen-Palmus, J., L″udke, D., and G″unnemann, S. Generative diffusion for 3d turbulent flows. arXiv preprint arXiv: 2306.01776, 2023.
Lippe, P., Veeling, B., Perdikaris, P., Turner, R., and Brandstetter, J. Pde-refiner: Achieving accurate long rollouts with neural pde solvers. Advances in Neural Information Processing Systems, 36, 2024.
Loshchilov, I. and Hutter, F. SGDR: stochastic gradient descent with warm restarts. In 5th International Conference on Learning Representations, ICLR 2017, Toulon, France, Apr. 24-26, 2017, Conference Track Proceedings. OpenReview.net, 2017.
Loshchilov, I. and Hutter, F. Decoupled weight decay regularization. In 7th International Conference on Learning Representations, ICLR 2019, New Orleans, LA, USA, May 6-9, 2019. OpenReview.net, 2019.
Lu, L., Jin, P., and Karniadakis, G. E. Deeponet: Learning nonlinear operators for identifying differential equations based on the universal approximation theorem of operators. arXiv preprint arXiv: 1910.03193, 2019.
Lu, L., Jin, P., Pang, G., Zhang, Z., and Karniadakis, G. E. Learning nonlinear operators via deeponet based on the universal approximation theorem of operators. Nature machine intelligence, 3 (3): 218-229, 2021.
Lucy, L. B. A numerical approach to the testing of the fission hypothesis. Astronomical Journal, vol. 82, December 1977, p. 1013-1024., 82:1013-1024, 1977.
Lusch, B., Kutz, J. N., and Brunton, S. L. Deep learning for universal linear embeddings of nonlinear dynamics. Nature communications, 9 (1): 4950, 2018.
Mathieu, J. and Scott, J. An introduction to turbulent flow. Cambridge University Press, 2000.
Mayr, A., Lehner, S., Mayrhofer, A., Kloss, C., Hochreiter, S., and Brandstetter, J. Boundary graph neural networks for 3d simulations. In Proceedings of the AAAI Conference on Artificial Intelligence, volume 37, pp. 9099-9107, 2023.
McCabe, M., Blancard, B. R.-S., Parker, L. H., Ohana, R., Cranmer, M., Bietti, A., Eickenberg, M., Golkar, S., Krawezik, G., Lanusse, F., et al. Multiple physics pretraining for physical surrogate models. arXiv preprint arXiv: 2310.02994, 2023.
Merchant, A., Batzner, S., Schoenholz, S. S., Aykol, M., Cheon, G., and Cubuk, E. D. Scaling deep learning for materials discovery. Nature, pp. 1-6, 2023.
Moin, P. and Mahesh, K. Direct numerical simulation: a tool in turbulence research. Annual review of fluid mechanics, 30 (1): 539-578, 1998.
Monaghan, J. J. Smoothed particle hydrodynamics. Annual review of astronomy and astrophysics, 30 (1): 543-574, 1992.
Monaghan, J. J. Smoothed particle hydrodynamics. Reports on progress in physics, 68 (8): 1703, 2005.
Monaghan, J. J. and Gingold, R. A. Shock simulation by the particle method sph. Journal of computational physics, 52 (2): 374-389, 1983.
Morris, J., Fox, P., and Zhu, Y. Modeling low reynolds number incompressible flows using sph. Journal of Computational Physics, 136, 1997.
Morton, J., Jameson, A., Kochenderfer, M. J., and Witherden, F. Deep dynamical modeling and control of unsteady fluid flows. Advances in Neural Information Processing Systems, 31, 2018.
Nair, V. and Hinton, G. E. Rectified linear units improve restricted boltzmann machines. In ICML, pp. 807-814. Omnipress, 2010.
Nguyen, T., Brandstetter, J., Kapoor, A., Gupta, J. K., and Grover, A. Climax: A foundation model for weather and climate. arXiv preprint arXiv: 2301.10343, 2023.
Olver, P. J. Introduction to partial differential equations. Springer, 2014.
Patankar, S. V. and Spalding, B. D. A calculation procedure for heat, mass and momentum transfer in three-dimensional parabolic flows. Int. J. of Heat and Mass Transfer, 15, 1972.
Peebles, W. and Xie, S. Scalable diffusion models with transformers. In ICCV, pp. 4172-4182. IEEE, 2023.
Perdikaris, P. A unifying framework for operator learning via neural fields, December 2023.
Perez, E., Strub, F., de Vries, H., Dumoulin, V., and Courville, A. C. Film: Visual reasoning with a general conditioning layer. pp. 3942-3951. AAAI Press, 2018.
Pfaff, T., Fortunato, M., Sanchez-Gonzalez, A., and Battaglia, P. W. Learning mesh-based simulation with graph networks. arXiv preprint arXiv: 2010.03409, 2020.
Pope, S. B. Turbulent flows. Measurement Science and Technology, 12 (11): 2020-2021, 2001. Raoni′c, B., Molinaro, R., Rohner, T., Mishra, S., and de Bezenac, E. Convolutional neural operators. arXiv preprint arXiv: 2302.01178, 2023.
Reynolds, O. Iv. on the dynamical theory of incompressible viscous fluids and the determination of the criterion. Philosophical transactions of the royal society of london. (a.), (186): 123-164, 1895.
Rombach, R., Blattmann, A., Lorenz, D., Esser, P., and Ommer, B. High-resolution image synthesis with latent diffusion models. In CVPR, pp. 10674-10685. IEEE, 2022.
Ronneberger, O., Fischer, P., and Brox, T. U-net: Convolutional networks for biomedical image segmentation. In MICCAI (3), volume 9351 of Lecture Notes in Computer Science, pp. 234-241. Springer, 2015.
Sanchez-Gonzalez, A., Godwin, J., Pfaff, T., Ying, R., Leskovec, J., and Battaglia, P. Learning to simulate complex physics with graph networks. In International conference on machine learning, pp. 8459-8468. PMLR, 2020.
Scarselli, F., Gori, M., Tsoi, A. C., Hagenbuchner, M., and Monfardini, G. The graph neural network model. IEEE transactions on neural networks, 20 (1): 61-80, 2008.
Seidman, J., Kissas, G., Perdikaris, P., and Pappas, G. J. Nomad: Nonlinear manifold decoders for operator learning. Advances in Neural Information Processing Systems, 35:5601-5613, 2022.
Shen, Z., Zhang, M., Zhao, H., Yi, S., and Li, H. Efficient attention: Attention with linear complexities. In WACV, pp. 3530-3538. IEEE, 2021.
Smagorinsky, J. General circulation experiments with the primitive equations: I. the basic experiment. Monthly weather review, 91 (3): 99-164, 1963.
Stachenfeld, K., Fielding, D. B., Kochkov, D., Cranmer, M., Pfaff, T., Godwin, J., Cui, C., Ho, S., Battaglia, P., and Sanchez-Gonzalez, A. Learned simulators for turbulence. In International Conference on Learning Representations, 2022.
Sulsky, D., Chen, Z., and Schreyer, H. L. A particle method for history-dependent materials. Computer methods in applied mechanics and engineering, 118 (1-2): 179-196, 1994.
Takamoto, M., Praditia, T., Leiteritz, R., MacKinlay, D., Alesiani, F., Pfl\ddot{ }uger, D., and Niepert, M. Pdebench: An extensive benchmark for scientific machine learning. Advances in Neural Information Processing Systems, 35:1596-1611, 2022.
Taylor, G. I. and Green, A. E. Mechanism of the production of small eddies from large ones. Proceedings of the Royal Society of London. Series A-Mathematical and Physical Sciences, 158 (895): 499-521, 1937.
Temam, R. Navier-Stokes equations: theory and numerical analysis, volume 343. American Mathematical Soc., 2001.
Thuerey, N., Holl, P., Mueller, M., Schnell, P., Trost, F., and Um, K. Physics-based deep learning. arXiv preprint arXiv: 2109.05237, 2021.
Toshev, A. P., Galletti, G., Brandstetter, J., Adami, S., and Adams, N. A. Learning lagrangian fluid mechanics with e (3)-equivariant graph neural networks. arXiv preprint arXiv: 2305.15603, 2023a.
Toshev, A. P., Galletti, G., Fritz, F., Adami, S., and Adams, N. A. Lagrangebench: A lagrangian fluid mechanics benchmarking suite. In 37th Conference on Neural Information Processing Systems (NeurIPS 2023) Track on Datasets and Benchmarks, 2023b.
Toshev, A. P., Erbesdobler, J. A., Adams, N. A., and Brandstetter, J. Neural sph: Improved neural modeling of lagrangian fluid dynamics. arXiv preprint arXiv: 2402.06275, 2024.
Tsai, T.-P. Lectures on Navier-Stokes equations, volume 192. American Mathematical Soc., 2018.
Umetani, N. and Bickel, B. Learning three-dimensional flow for interactive aerodynamic design. ACM Trans. Graph., 37 (4): 89, 2018.
Vaswani, A., Shazeer, N., Parmar, N., Uszkoreit, J., Jones, L., Gomez, A. N., Kaiser, Ł., and Polosukhin, I. Attention is all you need. Advances in neural information processing systems, 30, 2017.
Vinuesa, R. and Brunton, S. L. Enhancing computational fluid dynamics with machine learning. Nature Computational Science, 2 (6): 358-366, 2022.
Weiler, M., Geiger, M., Welling, M., Boomsma, W., and Cohen, T. S. 3d steerable cnns: Learning rotationally equivariant features in volumetric data. Advances in Neural Information Processing Systems, 31, 2018.
Weller, H. G., Tabor, G., Jasak, H., and Fureby, C. A tensorial approach to computational continuum mechanics using object-oriented techniques. Computers in physics, 12 (6): 620-631, 1998.
Wiewel, S., Becher, M., and Thuerey, N. Latent space physics: Towards learning the temporal evolution of fluid flow. In Computer graphics forum, volume 38, pp. 71-82. Wiley Online Library, 2019.
Wilcox, D. Formulation of the k-omega turbulence model revisited. AIAA Journal, 46 (11): 2823-2838, 2008.
Woo, S., Debnath, S., Hu, R., Chen, X., Liu, Z., Kweon, I. S., and Xie, S. Convnext V2: co-designing and scaling convnets with masked autoencoders. In IEEE/CVF Conference on Computer Vision and Pattern Recognition, CVPR 2023, Vancouver, BC, Canada, Jun. 17-24, 2023, pp. 16133-16142. IEEE, 2023.
Wu, H., Luo, H., Wang, H., Wang, J., and Long, M. Transolver: A fast transformer solver for pdes on general geometries. arXiv preprint arXiv: 2402.02366, 2024.
Wu, Y. and He, K. Group normalization. In ECCV (13), volume 11217 of Lecture Notes in Computer Science, pp. 3-19. Springer, 2018.
Xu, M., Han, J., Lou, A., Kossaifi, J., Ramanathan, A., Azizzadenesheli, K., Leskovec, J., Ermon, S., and Anandkumar, A. Equivariant graph neural operator for modeling 3d dynamics. arXiv preprint arXiv: 2401. 11037, 2024.
Yang, E., Bui, H. H., De Sterck, H., Nguyen, G. D., and Bouazza, A. A scalable parallel computing sph framework for predictions of geophysical granular flows. Computers and Geotechnics, 121:103474, 2020. ISSN 0266-352X.
Zeni, C., Pinsler, R., Z″ugner, D., Fowler, A., Horton, M., Fu, X., Shysheya, S., Crabb′e, J., Sun, L., Smith, J., et al. Mattergen: a generative model for inorganic materials design. arXiv preprint arXiv: 2312.03687, 2023.
Zhang, X., Wang, L., Helwig, J., Luo, Y., Fu, C., Xie, Y., Liu, M., Lin, Y., Xu, Z., Yan, K., et al. Artificial intelligence for science in quantum, atomistic, and continuum systems. arXiv preprint arXiv: 2307.08423, 2023.

Although specific exemplary embodiments of the invention have been described, the person skilled in the art will readily understand that alternative embodiments may comprise only individual aspects, components, building blocks, or subsets thereof, which may provide their individual benefits as disclosed herein.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Embodiments of the invention may be implemented on a computer system. The computer system may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system may comprise any circuit or combination of circuits. In one embodiment, the computer system may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), or any other type of processor or processing circuit. Other types of circuits that may be included in the computer system may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system may include one or more storage devices, which may include one or more memory elements suitable to the particular application, such as a main memory in the form of random-access memory (RAM), one or more hard drives, and/or one or more drives that handle removable media such as compact disks (CD), flash memory cards, digital video disk (DVD), and the like. The computer system may also include a display device, one or more speakers, and a keyboard and/or controller, which can include a mouse, trackball, touch screen, voice-recognition device, or any other device that permits a system user to input information into and receive information from the computer system.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier. Other embodiments comprise the computer program for performing one of the methods described herein, stored on a machine-readable carrier. In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitory. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein. A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

1. A system comprising a Universal Physics Transformer implemented on a data processing apparatus, the Universal Physics Transformer comprising:
an encoder configured to encode input data into a unified latent representation of the input data in a latent space;
an approximator configured to propagate the latent representation of the input data forward in time; and
a decoder configured to query the latent representation of the input data at arbitrary query positions.

2. The system of claim 1, wherein the encoder is configured to encode only an initial state of a system under consideration into the latent representation, and wherein the approximator is configured to iteratively propagate the latent representation forward in time in the latent space.

3. The system of claim 1, wherein the encoder is a hierarchical encoder.

4. The system of claim 3, wherein the input data comprises a point cloud and wherein the encoder is configured to, in a first hierarchy, process a selected plurality of supernodes based on the point cloud.

5. The system of claim 4, wherein the encoder comprises a message passing layer configured to pass messages only towards the selected plurality of supernodes.

6. The system of claim 1, wherein the encoder comprises one or more transformer blocks and a perceiver block forming a second hierarchy.

7. The system of claim 1, wherein the approximator comprises a plurality, in particular a stack, of transformer blocks.

8. The system of claim 1, wherein the latent representation uses a predefined fixed number of tokens.

9. A non-transitory computer-readable medium having stored thereon a computer program, the computer program comprising instructions which, when the program is executed by a computer, cause the computer to implement a Universal Physics Transformer on a data processing apparatus, the Universal Physics Transformer comprising:
an encoder configured to encode input data into a unified latent representation of the input data in a latent space;
an approximator configured to propagate the latent representation of the input data forward in time; and
a decoder configured to query the latent representation of the input data at arbitrary query positions.
